(19) United States
(12) Patent Application Publication
(10) Pub. No.: US 2003/0203114 A1
(43) Pub. Date: Oct. 30, 2003

(54) Back-coated upholstery fabrics and methods of making same

(76) Inventors: John L. Nash, Burlington, NC (US); Bradley G. Martin, Burlington, NC (US)

Correspondence Address: NIXON & VANDERHYE P.C., 8th Floor, 1100 North Glebe Road, Arlington, VA, 22201-4714, US

(21) Appl. No.: 10/132,735

(22) Filed: Apr. 26, 2002

(51) Int. Cl. B32B 27/04; B32B 3/00; B32B 15/00

(52) U.S. Cl. 427/256; 428/196; 428/156; 428/167; 442/104; 442/148; 427/286; 427/288

(57) ABSTRACT

Back-coated fabrics exhibit comparable physical attributes of unbacked fabrics (e.g., comparable hand, softness and/or bulk characteristics) while still being suitable for use in automated upholstery machinery (e.g., due to the fabrics excellent low seam slippage characteristics). The back-coating material is most preferably applied as a discontinuous geometric pattern to achieve an amount which is substantially less than conventional knife-coated continuous layers. Thus, the back-coating materials are applied most preferably in amounts of about 1.0 ounce per linear yard of the uncoated fabric or less, and more preferably about 0.50 ounce per linear yard or less. Notwithstanding the reduced amount of back-coating material, the fabrics of the present invention advantageously exhibit a seam strength (ASTM D4034) of about 25 pounds-force or greater thereby enabling the fabrics of the present invention to be suitable employed in automated upholstery machinery.

### FIELD OF THE INVENTION

The present invention relates generally to back-coated fabrics and their methods of manufacture. In particularly preferred embodiments, the present invention relates to upholstery fabrics which are screen printed on the technical back of the fabric with a back-coating material in a discontinuous pattern.

### BACKGROUND AND SUMMARY OF THE INVENTION

Upholstery fabrics are typically back-coated with a continuous layer or film of latex back-coating material to improve the performance of the fabric. Specifically, the back-coating serves to increase seam slippage, increase fabric stability and control raveling of the fabric filling yarns. Traditional methods to back-coat upholstery fabrics include applying the latex onto the technical back of the fabric by spraying and/or knife-coating techniques. These traditional application methods make it nearly impossible to consistently apply a specified amount from one run to another, especially when relatively small amounts of latex are desired to be applied.

It is important in today's upholstery market to provide fabrics which have pleasing physical attributes, namely good hand, softness and bulk. At the same time, upholsters demand that the fabric be suitable for automated upholstering applications, particularly high speed upholstery machines where raveling of the filling yarn can be quite problematic. To meet the upholsterers' requirements, the fabric is back-coated with a layer or film of latex back-coating material. The back-coating material, when applied as a layer or film according to conventional techniques briefly described above significantly adversely affects the physical attributes of the fabric—that is, presenting the fabric with less pleasing hand characteristics, as well as reduced softness and bulk.

It would therefore be desirable if a back-coated fabric could be provided which is suitable for automated processing, but has the physical attributes of unbacked fabrics. It is towards providing such a fabric that the present invention is directed.

Broadly, according to the present invention, back-coated fabrics exhibit comparable physical attributes of unbacked fabrics (e.g., comparable hand, softness and/or bulk characteristics) while still being suitable for use in automated upholstery machinery (e.g., due to the fabrics' excellent high seam slippage characteristics).

The back-coating material is most preferably applied as a discontinuous geometric pattern to achieve an amount which is substantially less than conventional knife-coated continuous layers. Thus, the back-coating materials are applied most preferably in amounts of about 1.5 ounces per linear yard of the uncoated fabric or less, and more preferably about 1.0 ounces per linear yard or less. Notwithstanding the reduced amount of back-coating material, the fabrics of the present invention advantageously exhibit a seam strength (ASTM D4034) of at least about 25 pounds-force (+/−) or greater thereby enabling the fabrics of the present invention to be suitably employed in automated upholstery machinery.

The discontinuous geometric array of back-coating material can take virtually any form. Thus, a geometric array of dots, grids, lines, indicia or virtually any other conceivable geometric pattern or design may be employed in the practice of the present invention. The geometric pattern is achieved by screen-printing the back-coating material onto the technical back side of an uncoated fabric.

These and other aspects and advantages of the present invention will become more clear after careful consideration is given to the following detailed description thereof.

### BRIEF DESCRIPTION OF THE ACCOMPANYING DRAWINGS

Reference will hereinafter be made to the accompanying drawing FIGURES, wherein

FIG. 1 is a view predominantly of the technical back of an upholstery fabric in accordance with the present invention; and

FIG. 2 is a schematic representation of the process steps that may be employed in the manufacture of the fabrics of this invention.

### DETAILED DESCRIPTION OF THE INVENTION

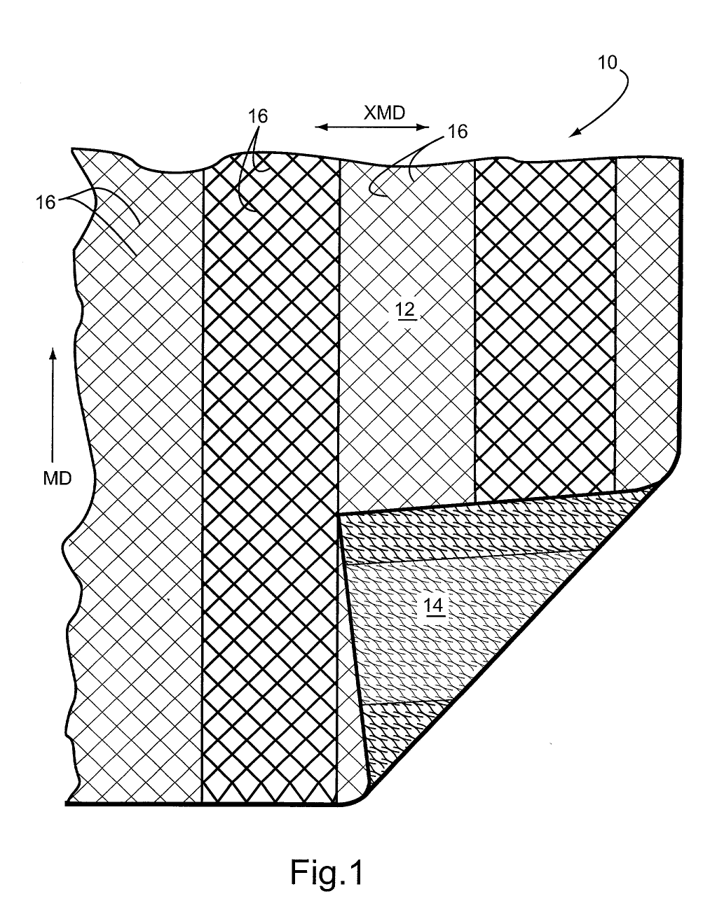

Accompanying FIG. 1 shows an exemplary back-coated upholstery fabric 10 in accordance with the present invention. As shown, the fabric 10 is single-ply (i.e., is not plied or otherwise adhered to any reinforcing fabric, scrim or the like) and has a technical back 12 predominantly visible in FIG. 1, and a front 14. The exemplary fabric 10 is shown as having a striped pattern of color shade fields oriented longitudinally in the machine (warp-wise) direction MD of the fabric alternating with one another in the cross-machine (filling-wise) XMD direction. Of course, any other decorative pattern may be chosen without departing from the scope of the present invention.

The back side 12 of fabric 10 includes a latex back-coating material printed thereon in a discontinuous pattern faintly visible in FIG. 1, but identified by reference numeral 16 therein. As shown, the pattern 16 is in the form of a regular (symmetric) grid pattern which is oriented on a bias (e.g., about 45°) relative to the machine (warp-wise) direction MD of the fabric 10 so as to visibly be presented as a diamond-like pattern.

The latex back-coating material that is applied onto the back 12 of fabric 10 in the form of a discontinuous pattern 16 can be any water-based material conventionally employed to back-coat fabrics. Virtually any water-based latex rubber material may be employed in the successful practice of this invention. Most preferably, the latex material is VULTEX® latex rubber. On particularly preferred VULTEX® latex rubber is VULTEX 14-J-3462-UPH commercially available from General Latex and Chemical Corporation, a division of Textile Rubber, Inc.

The latex back-coating material may be applied to the back 12 of fabric 10 in any desired discontinuous pattern. Thus, an array of dots, grids, lines, indicia or virtually any other conceivable geometric pattern or design may be employed in the practice of the present invention. The back-coating material is most preferably applied by screen-printing techniques. That is, the back 12 of the fabric 10 is presented to a screen printer which includes a rotary screen having the desired pattern. The liquid back-coating material is then transferred by the screen-printer through the rotary screen and onto the back 12 of the fabric 10. The back-coating material is thus printed onto the back 12 of the fabric 10 in the discontinuous pattern that may be desired. Most preferably, the back-coating material is applied in the form of square grid patter oriented at a bias of substantially about 45° relative to the warp-wise direction of the fabric.

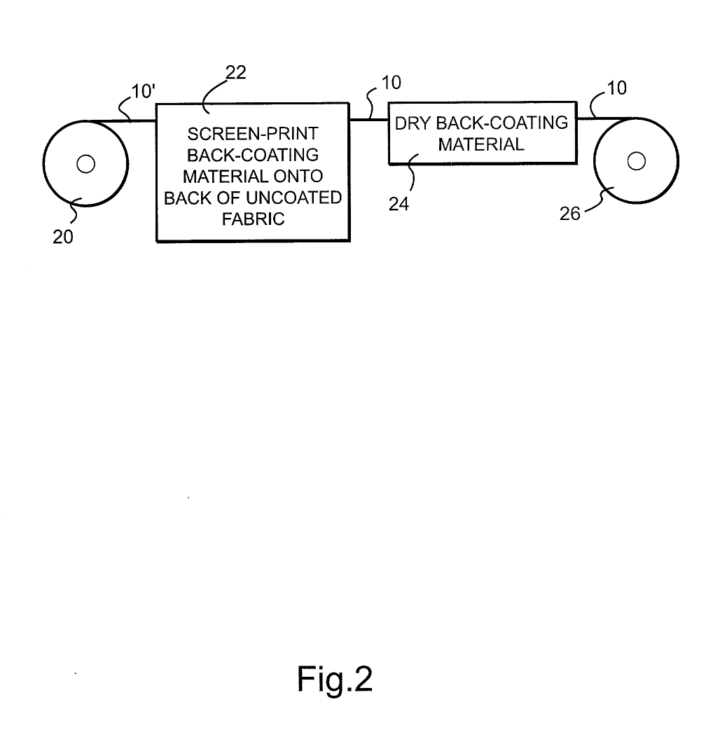

Accompanying FIG. 2 schematically shows the exemplary process steps that may be employed to form the back-coated fabric 10 in accordance with the present invention. In this regard, the uncoated fabric (designated 10′) is supplied from a roll 20 to step 22 where the back-coating material is applied by a screen printing machine onto the back side of the fabric 10′. The now back-coated fabric 10 is then supplied to step 24 where it is allowed to dry. Most preferably, the back-coated fabric 10 is dried in a relaxed state using a belt-dryer. The fabric 10 may thus be dried under non-tensioned conditions (e.g., by overfeeding the fabric 10 to the belt dryer). Less heat may also be employed as compared to conventional continuous layer-coated fabrics due to the lesser amount of back-coating material present. As a result, the back-coated fabric of this invention retains the hand, softness and bulk associated with unbacked fabrics. Once dried, the back-coated fabric may be taken-up on product roll 26.

The back-coated fabrics of this invention, however, are especially well suited for use with automatic upholstery equipment whereby the fabric is cut stitched and otherwise assembled as part of the furniture manufacturing process. Thus, the fabrics of the present invention are screen-printed with the back-coating material in amounts insufficient to affect the physical attributes of the fabric (e.g., so that the back-coated fabric is comparable to unbacked fabrics in terms of hand, softness and/or bulk) as mentioned previously, but sufficient to impart increased seam slippage comparable to conventional continuous layer-backed fabrics. Most preferably, the back-coating material is applied in an amounts less than about 1.0 ounce per linear yard, and more preferably in an amount of about 0.65 ounce per linear yard or less, and advantageously in an amount of about 0.50 ounce per linear yard or less. As an exemplary lower limit, the back-coating material may be applied in an amount satisfactory to achieve a slip strength of at least about 25 pounds-force (+/−) or greater in both the machine and cross-machine directions. Advantageously, the latex will therefore be present in an amount of at least about 0.35 ounce per linear yard or greater.

As used herein and in the accompanying claims the term “seam strength” is meant to imply the force in pounds needed to slip adjacently sewn fabric panels along their respective seam according to the Scott-Seam Method of ASTM D4034 entitled “Standard Test Method for Resistance to Yarn Slippage at the Sewn Seam in Woven Upholstery Fabrics” (the entire content of which is expressly incorporated hereinto by reference). Preferably, the back-coated fabrics of this invention will have a seam strength of at least about 25 pounds-force (+/−) or greater in both the machine and cross-machine directions.

The present invention will be further understood from the following non-limiting Examples.

### EXAMPLE I (INVENTION)

A number of commercially available woven upholstery fabrics from Burlington Industries, Inc. were back coated with a VULTEX® latex rubber back-coating material (VULTEX 14-J-3462-UPH from General Latex and Chemical Corporation using a screen to deposit a diamond-like matrix as shown in FIG. 1 in amounts of about 0.50 ounce per linear yard of the fabric or less. The screen employed was about 80 mesh having about 40% open screen surface area and was oriented at a bias of substantially 45° relative to the warp-wise direction of the fabrics. Seam strength data were obtained for each fabric sample according to ASTM D4034 and appear in Table 1 below.

The back-coated fabrics showed excellent hand and exhibited a satisfactory seam slippage of at least about 25 pounds-force (+/−) when subjected to ASTM D4034.

### EXAMPLE II (COMPARATIVE)

Example I was repeated except that the fabrics were not back-coated. Seam strength data were obtained for each such fabric sample and appear in Table 1 below in comparison to the comparable data for the fabric samples back-coated according to Example I.

TABLE 1

Seam Strength
(Pounds-force)

| | |
|---|---|
| Invention | Control |

| Sample | Fabric Style | Fabric Style | Add-On | (Back-Coated) | | (Uncoated) | |
|---|---|---|---|---|---|---|---|
| No. | Name | Number | (oz./linear yd) | Warp | Filling | Warp | Filling |
| 1 | MARLOW WASH | P2349 002A | .35 | 57 | 84 | 36 | 57 |
| 2 | KATHERINE | P2350 001A | .35 | 57 | 77 | 54 | 53 |
| 3 | FAYE | P2352 002A | .35 | 38 | 54 | 35 | 78 |
| 4 | CASTAWAY | P2354 001A | .35 | 44 | 51 | 37 | 44 |
| 5 | RANIER | P2356 001A | .35 | 32 | 47 | 30 | 57 |
| 6 | VENUE | P2357 001A | .35 | 24 | 30 | 23 | 59 |
| | DARLIN | P2351 002A | .50 | 27 | 56 | 33 | 46 |
| | TIVOLI | P2353 002A | .50 | 79 | 90 | 78 | 95 |
| | DANIELLE | P2355 002A | .50 | 39 | 53 | 44 | 46 |

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A back-coated upholstery fabric exhibiting comparable physical attributes of unbacked fabrics in terms of hand, softness and/or bulk characteristics, and having a seam strength of at least about 25 pounds-force or greater according to ASTM D4034 so as to be suitable for use in automated upholstery machinery.

2. A back-coated upholstery fabric as in claim 1, having a back-coating material applied as a discontinuous layer onto a technical back side of the fabric.

3. A back-coated upholstery fabric as in claim 2, wherein the back-coating material is a latex rubber material.

4. A back-coated upholstery fabric as in claim 2 or 3, wherein the back-coating material is present in an amount of about 1.0 ounce per linear yard of fabric or less.

5. A back-coated upholstery fabric as in claim 2 or 3, wherein the back-coating material is present in an amount of about 0.50 ounce per linear yard of fabric or less.

6. A back-coated upholstery fabric as in claim 2 or 3, wherein the back-coating material is present in an amount of between about 0.35 to about 1.0 ounce per linear yard of fabric.

7. A back-coated upholstery fabric as in claim 2, wherein the back-coating material is present on the back side of the fabric in the form of a geometric pattern of dots, grids, lines and/or indicia.

8. A back-coated upholstery fabric as in claim 7, wherein the geometric pattern is in the form of a regular symmetric grid pattern.

9. A back-coated upholstery fabric as in claim 8, wherein the grid pattern is oriented on a bias relative to the machine direction of the fabric.

10. A back-coated upholstery fabric as in claim 9, wherein the bias is about 45° relative to the warp-wise direction of the fabric.

11. A method of making a back-coated upholstery fabric comprising applying to an unbacked fabric a back-coating material in an amount sufficient to achieve seam strength of about 25 pounds-force or greater according to ASTM D4034, while maintaining physical attributes of the back-coated fabric comparable to the unbacked fabric, and drying the back-coating material.

12. A method as in claim 11, comprising applying the back-coating material as a discontinuous layer onto a technical back side of the fabric.

13. A method as in claim 12, wherein the back-coating material is a latex rubber material.

14. A method as in claim 12, wherein the back-coating material is present in an amount of about 1.0 ounce per linear yard of fabric or less.

15. A method as in claim 12, wherein the back-coating material is present in an amount of about 0.50 ounce per linear yard of fabric or less.

16. A method as in claim 12, wherein the back-coating material is present in an amount of between about 0.35 to about 1.0 ounce per linear yard of fabric.

17. A method as in claim 12, comprising applying the back-coating material onto the back side of the fabric in the form of a geometric pattern of dots, grids, lines and/or indicia.

18. A method as in claim 17, wherein the geometric pattern is in the form of a regular symmetric grid pattern.

19. A method as in claim 18, wherein the grid pattern is oriented on a bias relative to the machine direction of the fabric.

20. A method as in claim 19, wherein the bias is about 450 relative to the warp-wise direction of the fabric.

21. A method as in any one of claims 12-20, comprising screen-printing a geometric pattern of back-coating material onto the back side of the fabric.
